(19) United States
(12) Patent Application Publication
(10) Pub. No.: US 2023/0086887 A1
(43) Pub. Date: Mar. 23, 2023

(54) PLANNING SYSTEM FOR AN AUTONOMOUS WORK VEHICLE SYSTEM

(71) Applicant: CNH Industrial America LLC, New Holland, PA (US)

(72) Inventors: Brett McClelland, Chicago, IL (US); Joshua Harmon, Leola, PA (US)

(21) Appl. No.: 17/480,610

(22) Filed: Sep. 21, 2021

(51) Int. Cl. B60W 60/00; B60W 50/14

(52) U.S. Cl. CPC B60W 60/0025; B60W 50/14; B60W 2300/15; B60W 2720/10; B60W 2720/12; B60W 2555/20; B60W 2552/35; B60W 2552/15; B60W 2050/146

(57) ABSTRACT

A planning system for an autonomous work vehicle system includes a controller having a memory and a processor. The controller is configured to provide an indication of a work area for operation of the autonomous work vehicle system, identify a plurality of zones of the work area, and identify one or more rules for each respective zone of the plurality of zones. The one or more rules define operation of the autonomous work vehicle system in the respective zone. The controller is configured to generate a plan for operation of the autonomous work vehicle system based on the plurality of zones and the one or more rules for each respective zone of the plurality of zones.

### BACKGROUND

The present disclosure relates generally to a planning system for an autonomous work vehicle system.

Certain autonomous work vehicle systems are controlled based on a determined path through a field. The autonomous work vehicle system may follow the path and perform certain tasks along the path. For example, the autonomous work vehicle system may perform agricultural operations (e.g., seeding or planting, harvesting crops, etc.) along the path. The field may include geographic features (e.g., rocky outcroppings, inclines) that are not accounted for while generating the path through the field and while defining operations along the path. Accordingly, the autonomous work vehicle system may operate inefficiently at or near such geographic features.

### BRIEF DESCRIPTION

Certain embodiments commensurate in scope with the disclosed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In certain embodiments, a planning system for an autonomous work vehicle system includes a controller having a memory and a processor. The controller is configured to provide an indication of a work area for operation of the autonomous work vehicle system, identify a plurality of zones of the work area, and identify one or more rules for each respective zone of the plurality of zones. The one or more rules define operation of the autonomous work vehicle system in the respective zone. The controller is configured to generate a plan for operation of the autonomous work vehicle system based on the plurality of zones and the one or more rules for each respective zone of the plurality of zones.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an autonomous work vehicle system including an autonomous work vehicle and an agricultural implement coupled to the autonomous work vehicle;

FIG. 2 is a block diagram of an embodiment of a control system that may be employed within the autonomous work vehicle system of FIG. 1;

FIG. 3 is a schematic diagram of an embodiment of a user interface displaying a representation of a work area for operation of the autonomous work vehicle system of FIG. 1;

FIG. 4 is a schematic diagram of an embodiment of the user interface displaying the representation of the work area and a prompt for generating a plan for controlling the autonomous work vehicle system of FIG. 1;

FIG. 5 is a flow diagram of an embodiment of a process that may be employed by the control system of FIG. 2; and

FIG. 6 is a flow diagram of an embodiment of a process that may be employed by the control system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

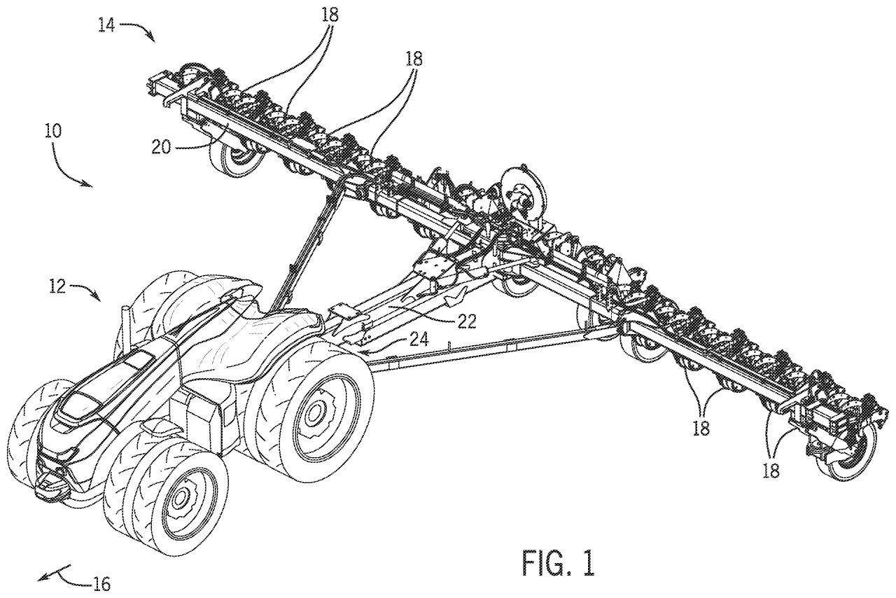

Turning now to the drawings, FIG. 1 is a perspective view of an embodiment of an autonomous work vehicle system 10 including an autonomous work vehicle 12 and an agricultural implement 14 coupled to the autonomous work vehicle 12. The autonomous work vehicle 12 includes a control system configured to automatically guide the autonomous work vehicle system 10 through a work area (e.g., along a direction of travel 16) to facilitate agricultural operations (e.g., planting operations, seeding operations, application operations, tillage operations, harvesting operations, etc.). For example, the control system may automatically guide the autonomous work vehicle system 10 through a work area (e.g., a field) without input from an operator. The control system may also automatically guide the autonomous work vehicle system 10 to perform certain actions in the work area. In some embodiments, the autonomous work vehicle may include a cab. An operator may be positioned in the cab and may view a user interface configured to display aspects of the planning system described herein, such as a plan for operating the autonomous work vehicle system.

In the illustrated embodiment, the agricultural implement 14 is a planter having multiple row units 18 distributed along a tool bar 20. Each row unit is configured to open a trench into the soil and deposit agricultural product (e.g., seed, fertilizer, etc.) into the trench, thereby establishing rows of deposited agricultural product. Certain row units may include a closing assembly to direct displaced soil into the trench and/or a packer wheel to pack soil onto the deposited agricultural product. The number of row units 18 mounted on the tool bar 20 and/or a length of the tool bar 20 may be particularly selected (e.g., based on a target row spacing, a size of the agricultural field, etc.). In the illustrated embodiment, the agricultural implement 14 includes a tow bar 22 extending between the tool bar 20 and a hitch assembly 24. The hitch assembly 24 is configured to couple the agricultural implement to a corresponding hitch assembly of the autonomous work vehicle 12. While a planter is coupled to the autonomous work vehicle 12 in the illustrated embodiment, other agricultural implements may be coupled to the autonomous work vehicle in other embodiments. For example, in certain embodiments, a seeder, an air cart, a mower, a tillage tool, a sprayer, or a combination thereof, among other suitable agricultural implements, may be coupled to the autonomous work vehicle.

In certain embodiments, a planning system is configured to determine a plan for the autonomous work vehicle system 10 and, in certain embodiments, one or more other autonomous work vehicle systems performing agricultural operations within the work area. The plan includes zones of a work area and rules for each zone that define operation of the autonomous work vehicle system(s) in the zones. For example, the rules may include adjusting a speed of the autonomous work vehicle system 10 and/or adjusting operation of the agricultural implement 14 in a particular zone. In certain embodiments, the planning system includes a control system configured to determine a plan including the zones and the rules of each zone. The control system may automatically determine the plan, such as based on satellite imagery indicating features of the work area and/or based on inputs provided by a user (e.g., an operator, an owner, etc.) of the autonomous work vehicle system 10. For example, the planning system may include a user interface that enables the user to identify the zones of the work area and to assign rules to the zones. In certain embodiments, the control system may suggest potential rules for certain zones, and the user may enable the user to select from the potential rules. The control system may generate the plan including the zones and the rules for each zone, and in some embodiments, control the autonomous work vehicle system 10 based on the generated plan. Accordingly, the planning system described herein may facilitate creation and/or modification of a plan for operating the autonomous work vehicle system 10. Additionally, the planning system may facilitate generating a plan for controlling the autonomous work vehicle system 10 based on zones of a work area and rules defining operation in each zone.

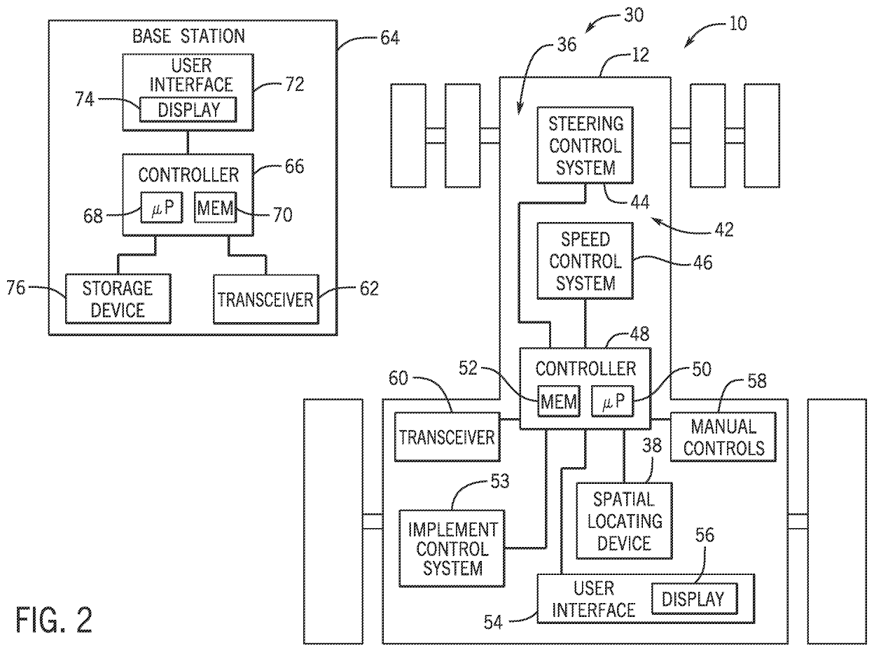

FIG. 2 is a block diagram of an embodiment of a control system 36 of a planning system 30 that may be employed within the autonomous work vehicle system 10 of FIG. 1. In the illustrated embodiment, the control system 36 includes a spatial locating device 38, which is mounted to the autonomous work vehicle 12 and configured to determine a position and, in certain embodiments, a velocity of the autonomous work vehicle 12. The spatial locating device 38 may include any suitable system configured to measure and/or determine the position of the autonomous work vehicle 12, such as a GPS receiver, for example.

In the illustrated embodiment, the control system 36 includes a movement control system 42 having a steering control system 44 configured to control a direction of movement of the autonomous work vehicle 12 and a speed control system 46 configured to control a speed of the autonomous work vehicle 12. In addition, the control system 36 includes a controller 48, which is communicatively coupled to the spatial locating device 38, to the steering control system 44, and to the speed control system 46. The controller 48 is configured to automatically control the autonomous work vehicle during certain phases of agricultural operations (e.g., without operator input, with limited operator input, etc.).

In certain embodiments, the controller 48 is an electronic controller having electrical circuitry configured to process data from the spatial locating device 38 and/or other components of the control system 36. In the illustrated embodiment, the controller 48 includes a processor 50, such as the illustrated microprocessor, and a memory device 52 (e.g., a memory). The controller 48 may also include one or more storage devices and/or other suitable components. The processor 50 may be used to execute software, such as software for controlling the autonomous work vehicle, software for determining a plan for the autonomous work vehicle system 10, and so forth. Moreover, the processor 50 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) processors.

The memory device 52 may include a volatile memory, such as random access memory (RAM), and/or a nonvolatile memory, such as read-only memory (ROM). The memory device 52 may store a variety of information and may be used for various purposes. For example, the memory device 52 may store processor-executable instructions (e.g., firmware or software) for the processor 50 to execute, such as instructions for controlling the autonomous work vehicle system 10, instructions for determining a plan for the autonomous work vehicle system 10, and so forth. In certain embodiments, the memory 52 may include one or more tangible, non-transitory, computer-readable media (e.g., machine-readable media) that store instructions executable by the processor 50 (e.g., configured to cause the processor 50 to perform certain actions) and/or data to be processed by the processor 50. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the autonomous work vehicle system 10, etc.), and any other suitable data.

In certain embodiments, the steering control system 44 may include a wheel angle control system, a differential braking system, a torque vectoring system, or a combination thereof. The wheel angle control system may automatically rotate one or more wheels and/or tracks of the autonomous work vehicle 12 (e.g., via hydraulic actuators) to steer the autonomous work vehicle along a target route through a work area. By way of example, the wheel angle control system may rotate front wheels/tracks, rear wheels/tracks, intermediate wheels/tracks, or a combination thereof, of the autonomous work vehicle 12 (e.g., either individually or in groups). The differential braking system may independently vary the braking force on each lateral side of the autonomous work vehicle 12 to direct the autonomous work vehicle 12 along a path. In addition, the torque vectoring system may differentially apply torque from an engine to wheel(s) and/or track(s) on each lateral side of the autonomous work vehicle 12, thereby directing the autonomous work vehicle 12 along a path. In further embodiments, the steering control system may include other and/or additional systems to facilitate directing the autonomous work vehicle 12 along a path through the work area.

In certain embodiments, the speed control system 46 may include an engine output control system, a transmission control system, a braking control system, or a combination thereof. The engine output control system may vary the output of the engine to control the speed of the autonomous work vehicle 12. For example, the engine output control system may vary a throttle setting of the engine, a fuel/air mixture of the engine, a timing of the engine, other suitable engine parameters to control engine output, or a combination thereof. In addition, the transmission control system may adjust a gear ratio of a transmission (e.g., by adjusting gear selection in a transmission with discrete gears, by controlling a continuously variable transmission (CVT), etc.) to control the speed of the autonomous work vehicle. Furthermore, the braking control system may adjust braking force, thereby controlling the speed of the autonomous work vehicle 12. In further embodiments, the speed control system may include other and/or additional systems to facilitate adjusting the speed of the autonomous work vehicle 12.

Additionally, the control system 36 includes an implement control system 53 configured to control the agricultural implement of the autonomous work vehicle system 10. The controller 48, which is communicatively coupled to the implement control system 53, is configured to automatically control the agricultural implement via the implement control system 53 during certain phases of agricultural operations (e.g., without operator input, with limited operator input, etc.). For example, the implement control system 53 is configured to control a steering angle of the implement (e.g., via an implement steering control system having a wheel angle control system and/or a differential braking system), a speed of the autonomous work vehicle system (e.g., via an implement speed control system having a braking control system), a height of the implement (e.g., via a hitch position control system configured to control a hitch of the autonomous work vehicle and/or hitch connection(s) of the implement, via an implement wheel position control system configured to control position(s) of wheel(s) of the implement), or a combination thereof. Additionally, the implement control system 53 is configured to control one or more tools of the implement (e.g., via a tool control system), one or more sub-frames of the implement (e.g., via a sub-frame control system), a product flow rate of the implement (e.g., via a flow rate control system), a position of the implement relative to the autonomous work vehicle 12, or a combination thereof

In certain embodiments, the implement control system 53 is configured to instruct actuator(s) to adjust a penetration depth of at least one ground engaging tool of the agricultural implement. By way of example, the implement control system 53 may instruct actuator(s) to reduce or increase the penetration depth of each tillage point on a tilling implement, or the implement control system 53 may instruct actuator(s) to engage or disengage each opener disc/blade of a seeding/planting implement from the soil. Furthermore, the implement control system 53 may instruct actuator(s) to transition the agricultural implement between a working position and a transport position, or to adjust a position of a header of the agricultural implement (e.g., a harvester, etc.), among other operations. The autonomous work vehicle control system may also include controller(s)/control system(s) for electrohydraulic remote(s), power take-off shaft(s), adjustable hitch(es), or a combination thereof, among other controllers/control systems.

As illustrated, the autonomous work vehicle 12 includes the implement control system 53. In some embodiments, the agricultural implement may include the implement control system, such as in place of or in addition to be included in the autonomous work vehicle, and/or the agricultural implement may include another control system/controller communicatively coupled to the controller of the autonomous work vehicle and/or to the implement control system of the autonomous work vehicle. For example, the autonomous work vehicle control system may be communicatively coupled to the control system/controller on the implement via a communication network, such as a controller area network (CAN bus).

In the illustrated embodiment, the control system 36 includes a user interface 54 (e.g., including a graphical user interface, a GUI) communicatively coupled to the controller 48. The user interface 54 is configured to enable an operator to control certain parameter(s) associated with operation of the autonomous work vehicle. For example, the user interface 54 may include a switch that enables the operator to selectively configure the autonomous work vehicle for autonomous or manual operation. In addition, the user interface 54 may include a battery cut-off switch, an engine ignition switch, a stop button, or a combination thereof, among other controls. In certain embodiments, the user interface 54 includes a display 56 configured to present information to the operator, such as a map of the work area, a visual representation of certain parameter(s) associated with operation of the autonomous work vehicle (e.g., fuel level, oil pressure, water temperature, etc.), and/or a visual representation of certain parameter(s) associated with operation of the agricultural implement coupled to the autonomous work vehicle (e.g., seed level, penetration depth of ground engaging tools, orientation(s)/position(s) of certain components of the implement, etc.), among other information. In certain embodiments, the display 56 may include a touch screen interface that enables the operator to control certain parameters associated with operation of the autonomous work vehicle and/or the agricultural implement. For example, as described in greater detail below, the user interface 54, via the display 56, may enable the operator to identify zones of a work area and rules defining operation of the autonomous work vehicle system 10 in the zones.

In the illustrated embodiment, the control system 36 includes manual controls 58 configured to enable an operator to control the autonomous work vehicle while automatic control is disengaged (e.g., while unloading the autonomous work vehicle from a trailer, etc.). The manual controls 58 may include manual steering control, manual transmission control, manual braking control, or a combination thereof, among other controls. In the illustrated embodiment, the manual controls 58 are communicatively coupled to the controller 48. The controller 48 is configured to disengage automatic control of the autonomous work vehicle upon receiving a signal indicative of manual control of the autonomous work vehicle. Accordingly, if an operator controls the autonomous work vehicle manually, the automatic control terminates, thereby enabling the operator to control the autonomous work vehicle.

In the illustrated embodiment, the control system 36 includes a transceiver 60 communicatively coupled to the controller 48. The transceiver 60 is configured to establish a communication link with a corresponding transceiver 62 of a base station 64, thereby facilitating communication between the base station 64 and the control system 36 of the autonomous work vehicle 12. The transceiver 60 may operate at any suitable frequency range within the electromagnetic spectrum. For example, in certain embodiments, the transceiver 60 may broadcast and receive radio waves within a frequency range of about 1 GHz to about 10 GHz. In addition, the transceiver 60 may utilize any suitable communication protocol, such as a standard protocol (e.g., Wi-Fi, Bluetooth, etc.) or a proprietary protocol. In certain embodiments, the base station 64 may be a handheld device, a laptop, or another suitable device.

In the illustrated embodiment, the base station 64 includes a controller 66 communicatively coupled to the base station transceiver 62. The controller 66 is configured to output commands and/or data to the controller 48 of the autonomous work vehicle 12. For example, the controller 66 may be configured to determine a plan and to output one or more signals indicative of the plan to the autonomous work vehicle controller 48, thereby enabling the autonomous work vehicle controller 48 to instruct the movement control system 42 to direct the autonomous work vehicle 12 along a route of the plan.

In certain embodiments, the controller 66 is an electronic controller having electrical circuitry configured to process data from certain components of the base station 64 (e.g., the transceiver 62). In the illustrated embodiment, the controller 66 includes a processor, such as the illustrated microprocessor 68, and a memory device 70. The processor 68 may be used to execute software, such as software for determining a plan, and so forth. Moreover, the processor 68 may include multiple microprocessors, one or more “general-purpose” microprocessors, one or more special-purpose microprocessors, and/or one or more application specific integrated circuits (ASICS), or some combination thereof. For example, the processor 68 may include one or more reduced instruction set (RISC) processors. The memory device 70 may include a volatile memory, such as RAM, and/or a nonvolatile memory, such as ROM. The memory device 70 may store a variety of information and may be used for various purposes. For example, the memory device 70 may store processor-executable instructions (e.g., firmware or software) for the processor 68 to execute, such as instructions for determining a plan.

In the illustrated embodiment, the base station 64 includes a user interface 72 communicatively coupled to the controller 66. The user interface 72 is configured to present data from the autonomous work vehicle 12 and/or the agricultural implement to an operator (e.g., data associated with operation of the autonomous work vehicle 12, data associated with operation of the agricultural implement, etc.). The user interface 72 is also configured to enable an operator to control certain functions of the autonomous work vehicle 12 (e.g., starting and stopping the autonomous work vehicle 12, instructing the autonomous work vehicle 12 to follow a route through the work area, etc.). In the illustrated embodiment, the user interface 72 includes a display 74 configured to present information to the operator, such as information about the work area, zones of the work area, rules for the zones, the position of the autonomous work vehicle system 10 within the work area, the speed of the autonomous work vehicle system 10, and the path of the autonomous work vehicle system 10, among other data.

In the illustrated embodiment, the base station 64 includes a storage device 76 communicatively coupled to the controller 66. The storage device 76 (e.g., nonvolatile storage) may include ROM, flash memory, a hard drive, or any other suitable optical, magnetic, or solid-state storage medium, or a combination thereof. The storage device(s) may store data, instructions (e.g., software or firmware for determining a plan, etc.), and any other suitable data. In some embodiments, the control system 36 may include the base station 64 or portion(s) thereof, such as the transceiver 62, the controller 66, the user interface 72, and/or the storage device 76. In certain embodiments, the control system may include other and/or additional controllers/control systems.

In certain embodiments, the controller 48 of the control system 36 of the planning system 30 is configured to determine a plan for the autonomous work vehicle system 10 including zones of a work area (e.g., a field) and rules defining operation of the autonomous work vehicle system 10 in each zone. For example, the controller 48 may generate the plan based on a map of the work area that indicates geographic features/regions (e.g., a rocky area, a wet area, a sandy area, a waterway, etc.) of the work area. The controller 48 may automatically identify such features and assign zones based on the features. Additionally, the controller 48 may assign rules to each zone that define operation of the autonomous work vehicle system 10 and/or may determine a route through the work area based on the zones. In some embodiments, the controller 48 may determine the plan based on user inputs. For example, the controller 48 may display the map of the work area via the user interface 54, and an operator may view the work area and identify zones of the work area, such as by selecting portions of the map and/or drawing the zones on the map via the user interface 54. The operator may assign rules for the zones, and the controller 48 may generate the plan based on the zones and rules identified by the operator. In certain embodiments, the operator may modify an existing plan (e.g., an initial plan generated by the control system 36, a plan previously generated or modified by the operator, etc.) via the user interface 54. Accordingly, the plan for controlling the autonomous work vehicle system 10 may be created, modified, and/or updated to account for geographic features in a work area.

In certain embodiments, the autonomous work vehicle controller 48 determines the plan and outputs instructions to execute the plan (e.g., outputs instructions to the movement control system 42 to direct the autonomous work vehicle 12 along and/or through zones of the plan). However, in further embodiments, the plan may be determined and/or instructions to execute the plan may be output by one or more other controllers. For example, in certain embodiments, the control system 36 of the planning system 30 includes the base station controller 66. In such embodiments, the base station controller 66 may determine the plan and output one or more signals indicative of the plan to the work vehicle controller 48 (e.g., via the respective transceivers). The work vehicle controller 48 may then output one or more signals indicative of instructions to execute the plan (e.g., instructions to the movement control system 42 to direct the autonomous work vehicle 12 along a route of the plan). In further embodiments, the base station controller 66 may determine the plan and output one or more signals to the movement control system 42 and/or other components of the work vehicle system (e.g., via the respective transceivers, via the autonomous work vehicle controller, etc.) indicative of instructions to execute the plan (e.g., instructions to direct the work vehicle along a route of the plan, etc.). In embodiments in which the control system 36 of the planning system 30 includes the base station controller 66, the base station controller 66 may determine the plan for multiple autonomous work vehicle systems and output one or more signals indicative of the plan (e.g., including respective routes of the plan) or instructions to execute the plan to each autonomous work vehicle system (e.g., to the controller of each autonomous work vehicle system, to the movement control system of each autonomous work vehicle system, etc.).

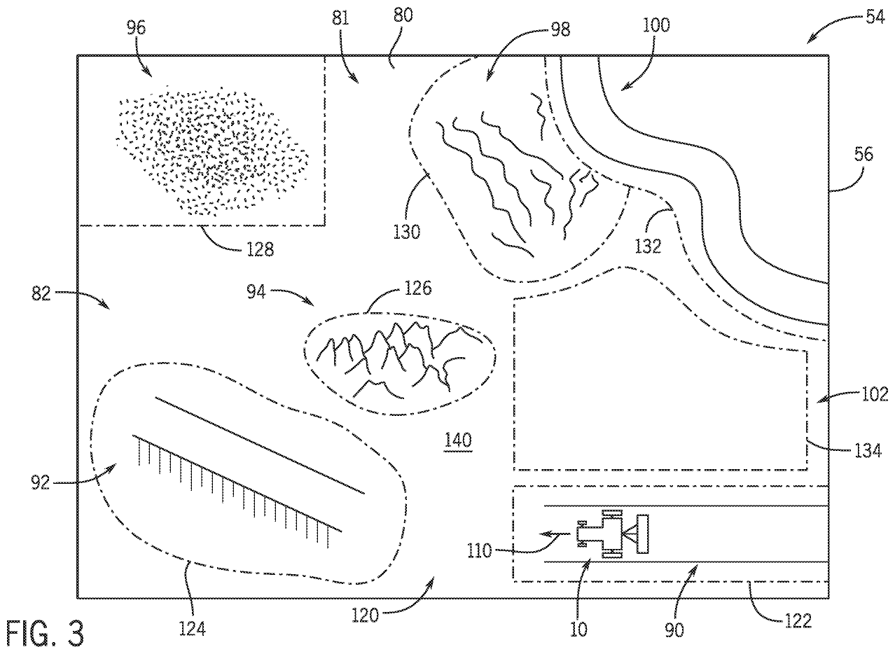

FIG. 3 is a schematic diagram of an embodiment of the user interface 54 (e.g., the display 56 of the user interface 54) displaying a representation of a work area 80 for operation of the autonomous work vehicle system 10 of FIG. 1. As illustrated, the work area 80 is represented as a map 81 including representations of geographic features 82 (e.g., geographic regions, etc.). For example, the map 81 may include a satellite image of the work area 80, an overhead image of the work area 80, a schematic representation of the work area 80, or a combination thereof. The geographic features 82 include a road 90, an incline 92, a rocky area 94, a sandy area 96, a wet area 98, a waterway 100, and a level area 102. In the illustrated embodiment, the map 81 includes a representation of the autonomous work vehicle system 10 travelling on the road 90 in a direction 110. The autonomous work vehicle system 10 may traverse the work area 80 (e.g., travel through, over, and/or around the geographic features 82) and perform agricultural operations in the work area 80.

The control system of the planning system may provide, via the user interface 54, the map 81 of the work area 80 based on imagery input to the control system, which may include satellite imagery and/or imagery captured via a drone or other device configured to capture overhead imagery. In certain embodiments, the control system may generate the map based on data gathered in the actual work area. For example, a user may traverse the work area, gather data indicative of the geographic features 82 while traversing the work area, such as via sensor(s) (e.g., accelerometer(s), moisture sensor(s), distance-measuring sensor(s), etc.), and provide the data to the control system. In some embodiments, the autonomous work vehicle system may traverse the work area to gather such data, such as automatically after a boundary of the work area is identified based on a user input. The control system may generate the map 81 of the work area 80 based on the received data. In some embodiments, the control system may generate the map 81 of the work area 80 as a schematic representation that includes characteristics distinguishing the geographic features 82 from one another and/or from other portions of the work area 80. For example, the map 81 displayed via the user interface 54 may include different icons, colors, and/or shapes representing the geographic features 82 and/or other portions of the work area 80.

As previously discussed, the control system is configured to determine a plan for operation of the autonomous work vehicle system 10 in the work area 80. In certain embodiments, the control system is configured to determine a plan having zones 120 in the work area. As explained in greater detail below, each zone 120 may have rule(s) that define operation of the autonomous work vehicle system 10 within the zone. For example, as the autonomous work vehicle system 10 enters a particular zone 120, the control system may control operation of the autonomous work vehicle system 10 based on the rules assigned to the particular zone 120.

As illustrated, the zones 120 include a zone 122 at the road 90, a zone 124 at the incline 92, a zone 126 at the rocky area 94, a zone 128 at the sandy area 96, a zone 130 at the wet area 98, a zone 132 at the waterway 100, and a zone 134 at the level area 102. The control system is configured to identify the zones 120 (e.g., shapes of the zones 120, types of the zones 120) based on the imagery and/or data indicative of the actual work area that is input to the autonomous work vehicle system 10. For example, the control system is configured to automatically recognize the geographic features 82 based on characteristics of the geographic features 82, differences in the topography among the geographic features 82 (e.g., differences in color and/or shading), via image recognition technology, and/or other suitable methods. The control system may identify a type of each zone 120 based on the topography and/or based on a default type of zone. The potential types of zones include a road (e.g., a pathway suitable for driving at high speeds relative to other portions of the work area), an incline, a rocky area, a sandy area, a wet area, a waterway, a level area, a crop area (e.g., an area having planted crops), a non-crop area (e.g., an area having no or few crops), a boundary of the work area (e.g., a fence line, a boundary separating the work area 80 from another work area), and other suitable types of zones that may generally correspond to geographic features of a work area. By way of example, the zone 126 may be identified as a rocky type of zone.

In certain embodiments, the type of the zone may be related to a particular agricultural operation independent of the geographic features of the work area. For example, the user may desire to plant different hybrids of seeds in different zones of the work area. The user may designate a first zone for a first hybrid of seed and a second zone for a second hybrid of seed. In another example, the user may desire to provide different seed spacings in different zones of the work area. In some embodiments, the user may desire to not plant seeds in a portion of the work area that would otherwise be suitable for planting. Accordingly, the user interface may enable the user to designate such a zone and identify a rule to drive the autonomous work vehicle system around the zone or to otherwise not plant seeds in the zone.

In certain embodiments, the control system may identify the zones 120 (e.g., shapes of the zones 120, types of the zones 120) based on an input provided by a user (e.g., operator, dealer, manufacturer, etc.) of the autonomous work vehicle system 10. In particular, the user interface 54 may display the map 81 of the work area 80, and the user may identify the zones 120 by providing an input to the user interface 54, such as by tapping on portions of the display 56 at the geographic regions 82. Such identification of the zones 120 may establish zones 120 having pre-defined shapes (e.g., circles, squares, rectangles, and other suitable shapes). In some embodiments, the user interface 54 may provide a menu of potential shapes, and the user may select the shapes of the zones 120 from the menu. In certain embodiments, the user may draw on the display 56 (e.g., via the user's hand, via a stylus, etc.) to identify the zones 120 (e.g., to create outlines/boundaries of the zones 120), thereby enabling the user to precisely define the zones 120 around the geographic features 82 that have irregular shapes. For example, while the zone 122 and the zone 128 have rectangular shapes, the zones 124, 126, 130, 132, and 134 have generally irregular shapes. Additionally, the user may identify a type of each zone 120. In certain embodiments, the control system may provide an initial representation of each zone and/or the type of each zone, and the user may modify the initial representation. For example, the user may modify a shape of a particular zone (e.g., by dragging a line on the user interface 54 via the user's finger or a stylus) and/or may modify the type of the particular zone.

Accordingly, the control system may automatically determine/identify a shape and/or type of each zone 120. In certain embodiments, the user may define/identify a shape and/or type of each zone 120, may modify or approve a shape and/or type of each zone 120 suggested by the control system, and/or may override the suggestion provided by the control system and provide a new shape and/or type of each zone 120. As such, the user interface 54 of the autonomous work vehicle system 10 may facilitate identifying the zones 120 (e.g., shapes of the zones 120, types of the zones 120) of the work area 80.

After identifying the zones 120, the control system is configured to identify rules for the zones 120 that define operation of the autonomous work vehicle system 10 within the zones 120, such as based on the type of the zone 120. In some embodiments, the control system may identify potential rules for the type of zone and choose one or more rules from among the potential rules based on certain parameters (e.g., evenness of the terrain of the zone, a size of the zone, a shape of the zone, etc.). For example, based on the zone 126 being a rocky type of zone, the control system is configured to identify potential rules including adjusting a speed of the autonomous work vehicle system 10 (e.g., adjusting the speed by a particular percentage decrease/increase and/or to a particular speed), raising the agricultural implement of the autonomous work vehicle system 10 while traversing the zone 126, and going around the zone 126. The control system is configured to choose one or more rules from among these rules based on the evenness of the zone 126 (e.g., a rockiness of the zone 126) and a size of the zone 126.

In some embodiments, the control system is configured to compare certain parameters to thresholds to determine the potential rules for a particular zone 120 and/or to automatically select the rule(s). For example, the control system may compare a moisture level of the zone 130 to a threshold moisture level. In response to the moisture level being greater than the threshold moisture level, the control system may determine that the rule(s) for the zone 130 include the autonomous work vehicle system 10 going around the zone 130. In response to the moisture level being less than the threshold moisture level, the control system may determine that the rule(s) include going through the zone 130 and raising the agricultural implement. In certain embodiments, the control system may identify other rule(s) for the zone 130 and/or rule(s) for other zones 120 based on comparisons of other parameters to thresholds.

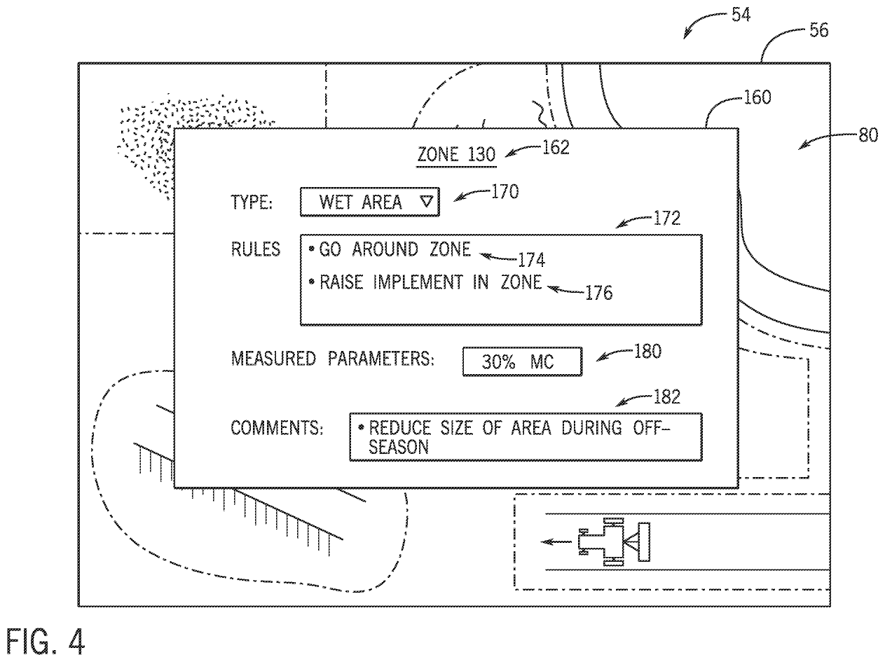

As described in greater detail in reference to FIG. 4, the control system is configured to provide a recommendation of potential rules to the user of the autonomous work vehicle system 10, thereby enabling the user to select the rules from among the potential rules. For example, after identifying the zones 120 (e.g., automatically or based on user input), the control system is configured to determine potential rules for each zone 120 and provide the recommendation(s) indicative of the potential rules, or a subset of the potential rules, to the user via the user interface 54. The user may review the potential rules and select rule(s) for each zone 120 from among the potential rules or approve all the potential rules recommended by the control system. In some embodiments, the control system may enable the user to select rule(s) for each zone 120 that are not included in potential and/or recommended rules, such as rules stored in a database. The user interface 54 may enable the user to search the database to identify and select the alternative rules. In certain embodiments, the control system may proceed with generating a plan for operation of the autonomous work vehicle system based on the potential rules and/or a subset of the potential rules independent of user input.

In certain embodiments, the control system is configured to identify the zone 122 as a roadway zone and, in response, to identify potential rules of the zone 122, such as raising the agricultural implement (e.g., if the implement is not already in a raised position) and/or adjusting a speed of the autonomous work vehicle system 10. The control system is configured to identify the potential rules and/or to automatically select rule(s) for the zone 122 (e.g., from among the potential rules) based on a type of the road 90 (e.g., dirt, gravel, pavement), a length of the road 90, a type of the autonomous work vehicle and/or the agricultural implement, a size of the autonomous work vehicle and/or the agricultural implement, a weight of the autonomous work vehicle and/or the agricultural implement (e.g., including a weight of agricultural product in the agricultural implement), other parameter(s) associated with the zone 122/autonomous work vehicle system 10, or a combination thereof.

In certain embodiments, the control system is configured to identify the zone 124 as an incline zone and, in response, to identify potential rules of the zone 124, such as lowering the agricultural implement (e.g., if the implement is not already in a lowered position), going around the zone 124, adjusting a speed of the autonomous work vehicle system 10, or a combination thereof. The control system is configured to identify the potential rules and/or to automatically select rules for the zone 124 (e.g., from among the potential rules) based on a steepness of the incline 92, a length of the incline 92, a type of the autonomous work vehicle and/or the agricultural implement, a size of the autonomous work vehicle and/or the agricultural implement, a weight of the autonomous work vehicle and/or the agricultural implement, other parameter(s) associated with the zone 124/autonomous work vehicle system 10, or a combination thereof.

In certain embodiments, the control system is configured to identify the zone 126 as a rocky zone and, in response, to identify potential rules of the zone 126, such as raising the agricultural implement (e.g., if the implement is not already in a raised position), adjusting an agricultural operation of the agricultural implement, going around the zone 126, adjusting a speed of the autonomous work vehicle system 10, or a combination thereof. The control system is configured to identify the potential rules and/or to automatically select rules for the zone 126 (e.g., from among the potential rules) based on how evenness of the zone 126 (e.g., a rockiness of the zone 126), a size of the zone 126, a type of the autonomous work vehicle and/or the agricultural implement, a size of the autonomous work vehicle and/or the agricultural implement, a weight of the autonomous work vehicle and/or the agricultural implement, other parameter(s) associated with the zone 126/autonomous work vehicle system 10, or a combination thereof

In certain embodiments, the control system is configured to identify the zone 128 as a sandy zone and, in response, to identify potential rules of the zone 128, such as raising or lowering the agricultural implement, adjusting an agricultural operation of the agricultural implement, adjusting a direction of travel through the zone 128, going around the zone 128, adjusting a speed of the autonomous work vehicle system 10, or a combination thereof. The control system is configured to identify the potential rules and/or to automatically select rules for the zone 128 (e.g., from among the potential rules) based on an amount of sand relative to other types of terrain in the zone 128, a size of the zone 128, a type of the autonomous work vehicle and/or the agricultural implement, a size of the autonomous work vehicle and/or the agricultural implement, a weight of the autonomous work vehicle and/or the agricultural implement, other parameter(s) associated with the zone 128/autonomous work vehicle system 10, or a combination thereof.

In certain embodiments, the control system is configured to identify the zone 130 as a wet zone and, in response, to identify potential rules of the zone 130, such as raising or lowering the agricultural implement, adjusting an agricultural operation of the agricultural implement, adjusting a direction of travel through the zone 130, going around the zone 130, adjusting a speed of the autonomous work vehicle system 10, or a combination thereof. The control system is configured to identify the potential rules and/or to automatically select rules for the zone 130 (e.g., from among the potential rules) based on a moisture content of the soil in the zone 130, a size of the zone 130, a type of the autonomous work vehicle and/or the agricultural implement, a size of the autonomous work vehicle and/or the agricultural implement, a weight of the autonomous work vehicle and/or the agricultural implement, other parameter(s) associated with the zone 130/autonomous work vehicle system 10, or a combination thereof

In certain embodiments, the control system is configured to identify the zone 132 as a waterway zone and, in response, to identify potential rules of the zone 132, such as raising or lowering the agricultural implement, adjusting an agricultural operation of the agricultural implement, adjusting a direction of travel through the zone 132, going around the zone 132, adjusting a speed of the autonomous work vehicle system 10, or a combination thereof. The control system is configured to identify the potential rules and/or to automatically select rules for the zone 132 (e.g., from among the potential rules) based on a size of the waterway 100 (e.g., a width, a length, and/or a depth of the waterway 100), a type of the autonomous work vehicle and/or the agricultural implement, a size of the autonomous work vehicle and/or the agricultural implement, a weight of the autonomous work vehicle and/or the agricultural implement, other parameter(s) associated with the zone 132/autonomous work vehicle system 10, or a combination thereof

In certain embodiments, the control system is configured to identify the zone 134 as a level zone and, in response, to identify potential rules of the zone 134, such as raising or lowering the agricultural implement, adjusting an agricultural operation of the agricultural implement, adjusting a direction of travel through the zone 134, adjusting a speed of the autonomous work vehicle system 10, or a combination thereof. The control system is configured to identify the potential rules and/or to automatically select rules for the zone 134 (e.g., from among the potential rules) based on a size of the zone 134, a type of the autonomous work vehicle and/or the agricultural implement, a size of the autonomous work vehicle and/or the agricultural implement, a weight of the autonomous work vehicle and/or the agricultural implement, other parameter(s) associated with the zone 134/autonomous work vehicle system 10, or a combination thereof

In certain embodiments, the control system is configured to identify a zone 140 of the zones 120 as a default zone of the work area 80. As illustrated, the zone 140 includes all portions of the work area 80 that are not included in the zones 122, 124, 126, 128, 130, 132, and 134. The zone 140 may be identified initially prior to identifying the other zones 120, and the portions of the other zones 120 may be removed from the zone 140 thereafter. The control system is configured to identify potential rules and/or to automatically select rules for the zone 140 (e.g., from among the potential rules) based on a size of the work area 80 and/or other parameter(s). The potential rules for the zone 140 may include default agricultural operations, a default speed of the autonomous work vehicle system 10, other suitable rule(s), or a combination thereof. After a portion of the zone 140 is identified as a new zone, the new zone may include the rule(s) identified for the zone 140 until new rule(s) are identified for the new zone and/or until receiving a user input removing the previous rule(s) from the new zone. In certain embodiments, the zones may not overlap, such that a same portion of the work area is not assigned to two different zones. In some embodiments, the zones may overlap, and the control system may resolve any differences between rules of the overlapping zones based on default rules identified by a user, default rules of the autonomous work vehicle system, user input, or a combination thereof. In certain embodiments, the overlapping zones may not have differences between rules.

In certain embodiments, the zones may overlap. For example, the zones 130 and 132 overlap in the illustrated embodiment. In such embodiments, the control system may resolve any conflicts from

After identifying the zones 120 and the rules for the zones 120, the control system is configured to generate a plan for operation of the autonomous work vehicle system 10. The plan may include a path of the autonomous work vehicle system 10 through the work area 80 (e.g., through the zones 120 of the work area 80) and operations to be performed by the autonomous work vehicle system 10 along the path that comply with the rules of each zone 120. For example, upon entering the zone 124 from the zone 140, the control system may adjust a speed of the autonomous work vehicle system 10, lower/raise the agricultural implement of the autonomous work vehicle system 10, adjust an agricultural operation of the agricultural implement, or a combination thereof. Upon exiting the zone 124, the control system may resume operations associated with the zone 140, such as by adjusting the speed of the autonomous work vehicle system 10, lowering/raising the agricultural implement, adjusting an agricultural operation of the agricultural implement, or a combination thereof.

In certain embodiments, the control system may determine the path of the autonomous work vehicle system 10 as an efficient (e.g., substantially optimized) path through the work area 80 based on the types of the zones 120 and/or the rules identified for each zone 120. For example, the determined path may reduce raising/lowering the agricultural implement, reduce an amount of turning of the autonomous work vehicle system 10 within the work area 80, reduce adjustments to the agricultural operations of the agricultural implement (e.g., switching between the agricultural operations), reduce changes to the speed of the autonomous work vehicle system 10, reduce costs associated with operating the autonomous work vehicle system 10, reduce a time period associated with operating the autonomous work vehicle system 10, otherwise enhance (e.g., substantially optimize) performance of the autonomous work vehicle system 10, or a combination thereof.

FIG. 4 is a schematic diagram of an embodiment of the user interface 54 displaying the representation of the work area 80 and a prompt 160 for generating a plan for controlling the autonomous work vehicle system of FIG. 1. In certain embodiments, the control system may generate the prompt 160 in response to a user selection and/or creation of a particular zone within the work area 80. In the illustrated embodiment, the prompt 160 is for the zone 130 (e.g., the wet area of the work area 80), as indicated by a title graphical element 162 of the prompt 160. In some embodiments, the title graphical element 162 may be modified via the user interface 54 to enable a user to provide a different name (e.g., identifier) for the zone 130.

The prompt 160 enables a user to identify and/or view information about the zone 160. For example, the prompt 160 includes a type graphical element 170, enabling the user to view and/or identify a type of the zone 130. As illustrated, the type is a wet area. The type graphical element 170 is a drop-down menu, enabling the user to select the wet area from a list of types of zones. In certain embodiments, the type graphical element may be a text box enabling the user to enter text identifying the type. The control system may review the text entered in the type graphical element to identify keywords corresponding to a stored type. For example, the control system may search the text for the term “wet” and, upon identifying the term, assign the type of “wet area” to the zone 130. In certain embodiments, the control system is configured to automatically identify the type of the zone 130 and present the type via the type graphical element 170, thereby enabling the user to view, approve, and/or modify the type identified by the control system.

Additionally, the prompt 160 includes a rules graphical element 172, enabling a user to identify and/or view potential rules for the zone 130. As illustrated, the rules graphical element 172 lists a first potential rule 174 (e.g., “GO AROUND ZONE”) and a second potential rule 176 (e.g., “RAISE THE IMPLEMENT IN ZONE”) that were previously identified as potential rules by the control system. The user may select one or more rules from among the potential rules. In the illustrated embodiment, the user may select one of the first potential rule 174 and the second potential rule 176 (e.g., the first potential rule 174 and the second potential rule 176 may be mutually exclusive). In response to a user selection, the control system may store an indication of the selected rule. In some embodiments, the prompt may include selectable options enabling the user to approve or decline a set of rules recommended by the control system for the zone. In certain embodiments, the user may add a rule defining operation of the autonomous work vehicle system in the zone 130 (e.g., the rules graphical element 172 may include a text field). In some embodiments, the prompt may include a selectable option for maintaining a default operation of the autonomous work vehicle system in the zone 130 (e.g., taking no different action upon entering the zone 130).

The prompt 160 also includes a measured parameters graphical element 180, enabling a user to identify (e.g., enter) and/or view certain measured parameter(s) associated with the zone 130. As illustrated, the measured parameters graphical element 180 is displaying a moisture content measurement (e.g., a moisture content of 30%) of the zone 130. Accordingly, the user may view the measured parameters graphical element 180 and use the measurements to determine which rules to select for the zone 130. In certain embodiments, the control system may automatically identify the rules and/or the potential rules (e.g., the rules to be recommended to the user) based on the measured parameters.

Further, the prompt 160 includes a comments graphical element 182, enabling a user to enter comments (e.g., notes) regarding the zone 130. As illustrated, the comment graphical element 182 is a free text box in which the user has entered the note of “REDUCE SIZE OF AREA DURING OFF-SEASON”. Accordingly, the user may enter such notes to facilitate storing information regarding the work area 80 and managing the work area 80. In certain embodiments, the title graphical element 162, the type graphical element 170, the rules graphical element 172, the measured parameters graphical element 180, the comment graphical element 182, or a combination thereof, may be omitted from the prompt 160. In some embodiments, certain graphical elements may be presented by the user interface via different and/or separate graphical elements, and/or the prompt may include additional graphical elements displaying information regarding the zone. The control system may provide a prompt for each zone of the work area, thereby enabling the user to view, identify, modify, and/or approve the zones, the types of the zones, the rules for the zones, and other information about the zones.

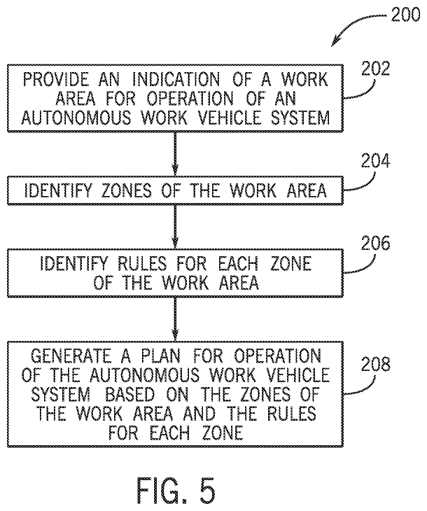

FIG. 5 is a flow diagram of an embodiment of a process 200 for generating a plan for controlling the autonomous work vehicle system. For example, the process 200, or portions thereof, may be performed by the control system described above (e.g., the controller of the autonomous work vehicle and/or the controller of the base station). Although the following description of the process 200 is described as including certain steps performed in a particular order, it should be understood that the steps of the process 200 may be performed in any suitable order, that certain steps may be omitted, and/or that certain steps may be added.

The process 200 begins at block 202, in which the control system provides an indication of the work area for operation of the autonomous work vehicle system. For example, the control system may receive and/or generate a map of the work area and display the map via the user interface of the autonomous work vehicle and/or via the user interface of the base station. The map may include representations of geographic features of the work area, such as a rocky area and a waterway.

At block 204, the control system identifies zones of the work area (e.g., types and/or shapes of the zones). For example, the control system may automatically identify the zones by recognizing geographic features of the work area based on differences in the topography among the geographic features (e.g., differences in color and/or shading), via image recognition technology, via other suitable method(s), or a combination thereof. In certain embodiments, the control system may identify a type of each zone based on the topography and/or based on a default type of zone. As described above, the potential types of zones include a road, an incline, a rocky area, a sandy area, a wet area, a waterway, a level area, a crop area, a boundary of the work area, other suitable types of zone(s) that may generally correspond to geographic features of a work area, or a combination thereof.

In some embodiments, the control system may receive a user input and identify the zones based on the user input. In particular, the user interface may display the map of the work area, and the user may identify the zones by providing an input to the user interface, such as by tapping on portions of the display at the geographic regions and/or by drawing on the display (e.g., via the user's hand, via a stylus, etc.). Additionally, the user may identify a type of each zone. Accordingly, the user interface of the autonomous work vehicle system may facilitate identifying the zones of the work area.

At block 206, the control system identifies rules for the zones of the work area that define operation of the autonomous work vehicle system in the zones. For example, the control system may automatically identify the rules based on the types of the zones. In certain embodiments, the control system may identify potential rules for the type of zone and choose one or more rules from among the potential rules based on measured parameter(s) of the zone. In some embodiments, the control system may provide a recommendation of potential rules to the user of the autonomous work vehicle system, thereby enabling the user to select the rule(s) from among the potential rules. In certain embodiments, the user interface may provide a free text field, enabling the user to enter (e.g., type) some or all rule(s) for each zone.

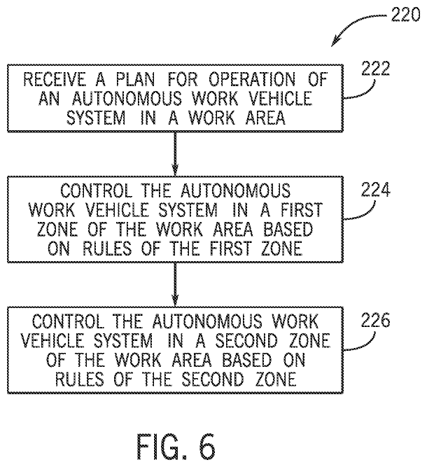

At block 208, the control system generates a plan for operation of the autonomous work vehicle system based on the zones of the work area and the rules identified for each zone. For example, the plan may include a path of the autonomous work vehicle system through the work area (e.g., through the zones of the work area) and operations to be performed by the autonomous work vehicle system along the path that comply with the rules of each zone. For example, the control system may generate a plan that enhances performance of the autonomous work vehicle system and/or reduces costs associated with operating the autonomous work vehicle system within the work area based on the rules of each zone. After generating the plan, the control system may output the plan to enable controlling the autonomous work vehicle system in accordance with the plan. In certain embodiments, as described in reference to FIG. 6, the control system may control the autonomous work vehicle system in accordance with the plan.

FIG. 6 is a flow diagram of an embodiment of a process 220 for executing a plan for controlling the autonomous work vehicle system. For example, the process 220, or portions thereof, may be performed by the control system described above (e.g., the controller of the autonomous work vehicle and/or the controller of the base station). Although the following description of the process 220 is described as including certain steps performed in a particular order, it should be understood that the steps of the process 220 may be performed in any suitable order, that certain steps may be omitted, and/or that certain steps may be added.

The process 220 begins at block 222, in which the control system receives a plan for operation of an autonomous work vehicle system within a work area. The plan may include zones of the work area and rules defining operation of the autonomous work vehicle system in each zone. In certain embodiments, the plan may be generated by the control system, such as via the process described in reference to FIG. 5. In some embodiments, a controller of the control system (e.g., the controller of the autonomous work vehicle or the controller of the base station) may generate the plan and output the plan to another controller of the control system (e.g., the other of the controller of the autonomous work vehicle or the controller of the base station). The other controller may receive and execute the plan.

At block 224, the control system controls the autonomous work vehicle system in a first zone of the work area based on rule(s) of the first zone. In certain embodiments, the control system may begin controlling the autonomous work vehicle system upon the autonomous work vehicle system entering the first zone and may control the autonomous work vehicle system to perform a first action based on the rule(s). For example, the first zone may be a default zone of the work area that includes a set of default rule(s) defining operation of the autonomous work vehicle system. The first action performed based on the default rule(s) may include adjusting a particular agricultural operation of the agricultural implement, adjusting a speed of the autonomous work vehicle system, other suitable rule(s), or a combination thereof. The control system may begin controlling the autonomous work vehicle system in accordance with such rule(s) upon the autonomous work vehicle system entering the first zone.

At block 226, the control system controls the autonomous work vehicle system in a second zone of the work area based on rule(s) of the second zone. The second zone may be adjacent to the first zone, such that the control system begins controlling the autonomous work vehicle system in accordance with the rule(s) of the second zone upon the autonomous work vehicle system exiting the first zone and entering the second zone. In certain embodiments, the control system may control the autonomous work vehicle system to perform a second action in the second zone, where the second action is different from the first action performed in the first zone. For example, the rule(s) of the second zone may be different from the rule(s) of the first zone, such that the control system adjusts operation of the autonomous work vehicle system as the autonomous work vehicle system transitions from the first zone to the second zone. In some embodiments, the work area may include additional zones, and the control system may control the autonomous work vehicle system in the additional zones in accordance with rules of the additional zones.

Accordingly, the control system of the planning system described herein facilitates generation of a plan for controlling the autonomous work vehicle system. For example, the control system may automatically identify zones of a work area and/or rules for the zones that define operation of the autonomous work vehicle system. Additionally, the control system may include a user interface, enabling a user to identify the zones and/or the rules for the zones. The control system may generate the plan for controlling the autonomous work vehicle system based on the zones and the rules for the zones. Further, the control system may control the autonomous work vehicle system based on the generated plan. As such, the control system may reduce time and costs associated with generating the plan, reduce time and costs associated with operating the autonomous work vehicle system in the work area, and facilitate controlling the autonomous work vehicle system in accordance with the generated plan.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A planning system for an autonomous work vehicle system, comprising:
a controller comprising a memory and a processor, wherein the controller is configured to:
provide an indication of a work area for operation of the autonomous work vehicle system;
identify a plurality of zones of the work area;
identify one or more rules for each respective zone of the plurality of zones, wherein the one or more rules define operation of the autonomous work vehicle system in the respective zone; and
generate a plan for operation of the autonomous work vehicle system based on the plurality of zones and the one or more rules for each respective zone of the plurality of zones.

2. The planning system of claim 1, wherein the controller is configured to provide the indication of the work area by instructing a user interface to display a map of the work area.

3. The planning system of claim 2, wherein identifying the plurality of zones comprises receiving, via the user interface, at least one user input indicating a respective zone of the plurality of zones as a respective portion of the map.

4. The planning system of claim 3, wherein the at least one user input comprises an outline of the respective portion of the map drawn on the user interface.

5. The planning system of claim 1, wherein the controller is configured to identify the plurality of zones by receiving a respective plurality of indications of types of the plurality of zones.

6. The planning system of claim 1, wherein the controller is configured to identify the plurality of zones by automatically identifying types of the plurality of zones based on one or more characteristics of each zone of the plurality of zones.

7. The planning system of claim 5, wherein the controller is configured to identify the one or more rules for each respective zone of the plurality of zones by automatically identifying the one or more rules based on the type of the respective zone.

8. The planning system of claim 1, wherein identifying the one or more rules for each respective zone of the plurality of zones comprises:
providing a recommendation indicating one or more potential rules for each respective zone; and
receiving a selection of the one or more rules for each respective zone from among the one or more potential rules.

9. The planning system of claim 1, wherein the controller is configured to control operation of the autonomous work vehicle system based on the plan.

10. A method of operating an autonomous work vehicle system, comprising:
generating a plan for operation of the autonomous work vehicle system in a work area based on a plurality of zones of the work area and one or more rules for each respective zone of the plurality of zones, wherein the one or more rules define operation of the autonomous work vehicle system in the respective zone; and
controlling the autonomous work vehicle system in each respective zone of the plurality of zones based on the one or more rules for the respective zone.

11. The method of claim 10, wherein controlling the autonomous work vehicle system in each respective zone of the plurality of zones based on the one or more rules for the respective zone comprises:
controlling the autonomous work vehicle system to perform a first action in a first zone of the plurality of zones; and
controlling the autonomous work vehicle system to perform a second action in a second zone of the plurality of zones, wherein the second action is different from the first action.

12. The method of claim 11, wherein the first action and the second action comprise adjusting a speed of the autonomous work vehicle system, adjusting an agricultural operation of an agricultural implement of the autonomous work vehicle system, or a combination thereof.

13. The method of claim 10, receiving a user input defining the plurality of zones, the one or more rules for each respective zone of the plurality of zones, or both.

14. The method of claim 10, comprising identifying the plurality of zones by automatically identifying types of the plurality of zones based on one or more characteristics of each zone of the plurality of zones.

15. The method of claim 14, wherein the types of the plurality of zones comprise a rocky area, a wet area, a sandy area, a waterway, a road, an incline, a level area, or a combination thereof.

16. One or more tangible, non-transitory, machine-readable media comprising instructions configured to cause a processor to:
display a map of a work area for operation of an autonomous work vehicle system;
receive a user input indicative of a plurality of zones of the work area, wherein each zone of the plurality of zones is assigned to a geographic feature of the work area;
identify one or more rules for each respective zone of the plurality of zones, wherein the one or more rules define operation of the autonomous work vehicle system at the geographic feature of each respective zone of the plurality of zones; and
generate a plan for operation of the autonomous work vehicle system based on the plurality of zones and the one or more rules for each respective zone of the plurality of zones.

17. The one or more tangible, non-transitory, machine-readable media of claim 16, wherein the instructions are configured to cause the processor to control operation of the autonomous work vehicle system based on the plan.

18. The one or more tangible, non-transitory, machine-readable media of claim 16, wherein the user input is indicative of a type of each zone of the plurality of zones.

19. The one or more tangible, non-transitory, machine-readable media of claim 18, wherein the types of the plurality of zones comprise a rocky area, a wet area, a sandy area, a waterway, a road, an incline, a level area, or a combination thereof

20. The one or more tangible, non-transitory, machine-readable media of claim 18, wherein the instructions are configured to cause the processor to:
provide a recommendation indicating one or more potential rules for each respective zone of the plurality of zones based on the type of the zone; and
receive a selection of the one or more rules for each respective zone from among the one or more potential rules.
